(19) United States
(12) Patent Application Publication
(10) Pub. No.: US 2025/0323001 A1
(43) Pub. Date: Oct. 16, 2025

(54) Insulation Base and Relay

(71) Applicant: Tyco Electronics (Shanghai) Co., Ltd., Shanghai (CN)

(72) Inventors: Jun Tod Chen, Shenzhen (CN); Jinlin Xu, Shanghai (CN)

(73) Assignee: Tyco Electronics (Shanghai) Co., Ltd., Shanghai (CN)

(21) Appl. No.: 19/175,531

(22) Filed: Apr. 10, 2025

(30) Foreign Application Priority Data
Apr. 10, 2024 (CN) 202410432857.4

(51) Int. Cl. H01H 50/04; H01H 9/44; H01H 50/18; H01H 50/36; H01H 50/44

(52) U.S. Cl. CPC H01H 50/04; H01H 9/443; H01H 50/18; H01H 50/36; H01H 50/44

(57) ABSTRACT

An insulation base adapted to be installed into a bottom opening of a housing of a relay includes a peripheral wall, a bottom wall connected to a bottom of the peripheral wall, and a partition wall. The partition wall is connected to the peripheral wall and the bottom wall. The partition wall divides an internal space defined by the housing and the insulation base into a containment chamber and an arc extinguishing chamber. Two recesses are formed on the inner side of the bottom wall of the arc extinguishing chamber, so that an electric arc between a static contact and a movable contact of the relay can be pulled down into the recess to increase a length of the electric arc.

### CROSS-REFERENCE TO RELATED APPLICATION

This application claims the benefit of Chinese Patent Application No. CN202410432857.4 filed on Apr. 10, 2024 in the State Intellectual Property Office of China, the whole disclosure of which is incorporated herein by reference.

### FIELD OF THE DISCLOSURE

This disclosure relates to an electrical assembly configured to install electronic devices and a liquid-cooled electronic system, and more specifically, to an electronic assembly for installing electronic devices, for example in a field of electronic technology, which is configured to cool the electronic devices in a sealed package form; and to a liquid-cooled electronic system comprising the electronic assembly and the electronic devices.

### BACKGROUND OF THE INVENTION

In the prior art, an electromagnetic relay typically includes an insulation base, a movable contact, a static contact, and a movable leaf spring. The insulation base includes a peripheral wall, a bottom wall, and a partition wall. The partition wall divides the space inside the insulation base into a containment chamber and an arc extinguishing chamber. The movable contact, static contact, and movable leaf spring are set in the arc extinguishing chamber. The movable contact is fixed to the end of the movable leaf spring. In order to increase the length of the movable leaf spring, the end of the movable leaf spring is usually made close to the bottom wall of the insulation base, which results in a too short distance between the movable contact and the bottom wall of the insulation base. When extinguishing the electric arc with magnetic force, the length of the electric arc pulled down between the movable contact and the static contact is limited, making it difficult to elongate to a predetermined length, which can reduce the effectiveness of the magnetic extinguishing arc and even cause arc extinguishing failure. Once the electric arc cannot be quickly extinguished, it will cause the movable and static contacts to be melted by the high temperature generated by the electric arc, and even cause the electromagnetic relay to explode, seriously affecting safety production.

In addition, in the prior art, a relay also includes a yoke, an armature, an insulator, and a connecting piece. The armature is movably installed on the yoke and can swing relative to the yoke between the suction position and the initial position. One end of the armature is connected to the insulator. One end of the connecting piece is joined to the insulator. The insulator electrically isolates the armature from the connecting piece. The movable leaf spring of the relay is riveted to the other end of the connecting piece. In the prior art, the need to provide separate connection pieces increases the number of components in the relay, resulting in increased costs. Moreover, riveting the movable leaf spring and the connecting piece will reduce production efficiency.

A relay of the prior art also includes a reset leaf spring for resetting the armature from the suction position to the initial position. The reset leaf spring is usually fixed to the partition wall of the insulation base. Due to the fact that the insulation base is usually made of plastic, its mechanical strength and wear resistance are poor. When the reset leaf spring is frequently moved, the partition wall of the insulation base is prone to rupture or wear. The plastic dust generated by wear can affect the electrical contact performance between movable and static contacts.

### SUMMARY OF THE INVENTION

According to an embodiment of the present disclosure, an insulation base adapted to be installed into a bottom opening of a housing of a relay includes a peripheral wall, a bottom wall connected to a bottom of the peripheral wall, and a partition wall. The partition wall is connected to the peripheral wall and the bottom wall. The partition wall divides an internal space defined by the housing and the insulation base into a containment chamber and an arc extinguishing chamber. Two recesses are formed on the inner side of the bottom wall of the arc extinguishing chamber, so that an electric arc between a static contact and a movable contact of the relay can be pulled down into the recess to increase a length of the electric arc.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a relay according to an exemplary embodiment of the present invention;

FIG. 2 shows a transverse sectional view of a relay according to an exemplary embodiment of the present invention;

FIG. 3 shows a longitudinal sectional view of a relay insulation base and housing according to an exemplary embodiment of the present invention;

FIG. 4 shows a transverse sectional view of a relay according to an exemplary embodiment of the present invention, where the housing is not shown;

FIG. 5 shows a longitudinal sectional view of a relay according to an exemplary embodiment of the present invention, where the housing is not shown;

FIG. 6 shows a plan sectional view of a relay according to an exemplary embodiment of the present invention, in which the movable contact and the static contact are in an electrically separated open position;

FIG. 7 shows a plan sectional view of a relay according to an exemplary embodiment of the present invention, in which the movable contact and the static contact are in the closed position of electrical contact;

FIG. 8 shows an illustrative perspective view of a relay module according to an exemplary embodiment of the present invention;

FIG. 9 shows a cross-sectional view of a relay module according to an exemplary embodiment of the present invention;

FIG. 10 shows an illustrative exploded view of a relay module according to an exemplary embodiment of the present invention;

FIG. 11 shows an exploded sectional view of a relay module according to an exemplary embodiment of the present invention;

FIG. 12 shows an illustrative exploded view of a relay armature assembly according to an exemplary embodiment of the present invention;

FIG. 13 shows an illustrative assembly view of the yoke and reset leaf spring of a relay according to an exemplary embodiment of the present invention;

FIG. 14 shows an illustrative perspective view of the reset leaf spring of a relay according to an exemplary embodiment of the present invention;

FIG. 15 shows a cross-sectional view of the reset leaf spring of a relay according to an exemplary embodiment of the present invention;

FIG. 16 shows a cross-sectional view of the yoke and reset leaf spring of a relay according to an exemplary embodiment of the present invention; and

FIG. 17 shows a cross-sectional view of the yoke, reset leaf spring, and insulation base of a relay according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, an insulation base for installation into a bottom opening of a housing of a relay comprises: a peripheral wall; a bottom wall connected to the bottom of the peripheral wall; and a partition wall connected to the peripheral wall and the bottom wall. The partition wall is used to divide an internal space defined by the housing and the insulation base into a containment chamber and an arc extinguishing chamber; two recesses are formed on the inner side of the bottom wall of the arc extinguishing chamber, so that an electric arc between a static contact and a movable contact of the relay can be pulled down into the recess to increase the length of the electric arc being pulled down.

According to an embodiment of the present disclosure, a relay comprises: a housing formed with a bottom opening; the above insulation base installed into the bottom opening of the housing; two static contacts located in the arc extinguishing chamber; two movable contacts located in the arc extinguishing chamber for electrical contact with the two static contacts respectively; and two arc extinguishing magnets located in the arc extinguishing chamber for extinguishing an electric arc between the static contact and the movable contact by magnetic blowing. The two recesses on the bottom wall of the arc extinguishing chamber are respectively located below the two movable contacts and between the two arc extinguishing magnets, so that the electric arc between the static contact and the movable contact can be pulled down into the recess by a magnetic field between the two arc extinguishing magnets.

According to an embodiment of the present disclosure, a relay armature assembly comprises: an armature which is suitable for being movably installed on a yoke of a relay, and can swing relative to the yoke between an initial position and a suction position; a movable leaf spring adapted to be connected to a movable contact assembly of the relay, for applying elastic contact force to the movable contact assembly; and an insulator. The armature and the movable leaf spring are fixed to the insulator and electrically isolated from each other by the insulator.

According to an embodiment of the present disclosure, a relay module comprises: a yoke which is fixed to the insulation base of a relay; a magnetic core with its lower end fixed to the yoke; the above relay armature assembly, wherein the armature is movably mounted on the yoke and can swing between a suction position in contact with the upper end of the magnetic core and an initial position separated from the upper end of the magnetic core; and a reset leaf spring fixed to the yoke and pressed onto the armature, used to reset the armature from the suction position to the initial position. The magnetic core and the reset leaf spring are respectively arranged on both sides of the yoke, the magnetic core is used to apply electromagnetic attraction to the armature, and the reset leaf spring is used to apply elastic reset force to the armature.

According to an embodiment of the present disclosure, a relay comprises: a housing with a bottom opening; the above relay module arranged in the housing; an insulation base installed into the bottom opening of the housing; and two static contact assemblies fixed to the insulation base for electrical contact with a movable contact assembly.

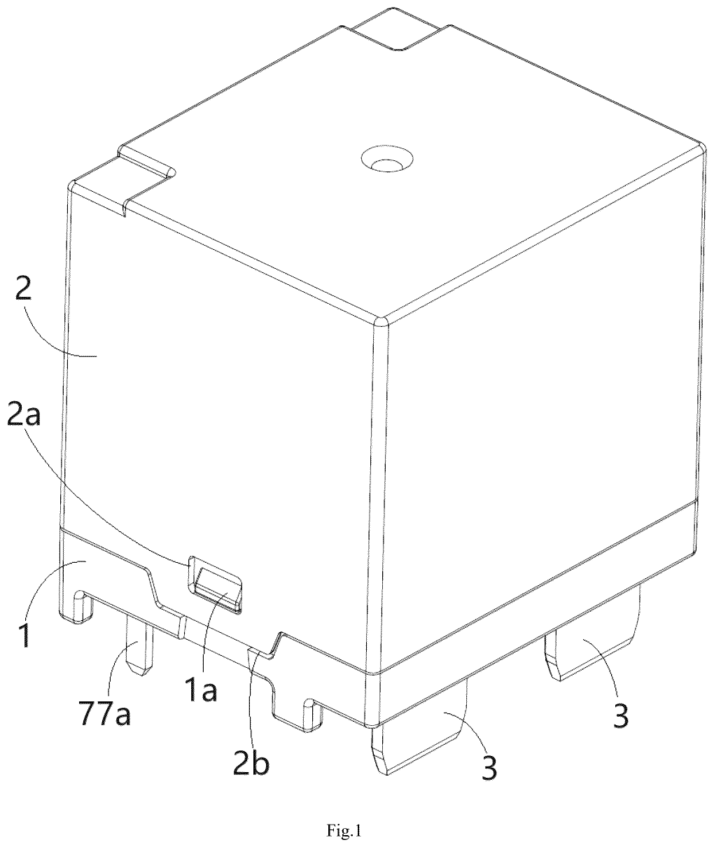

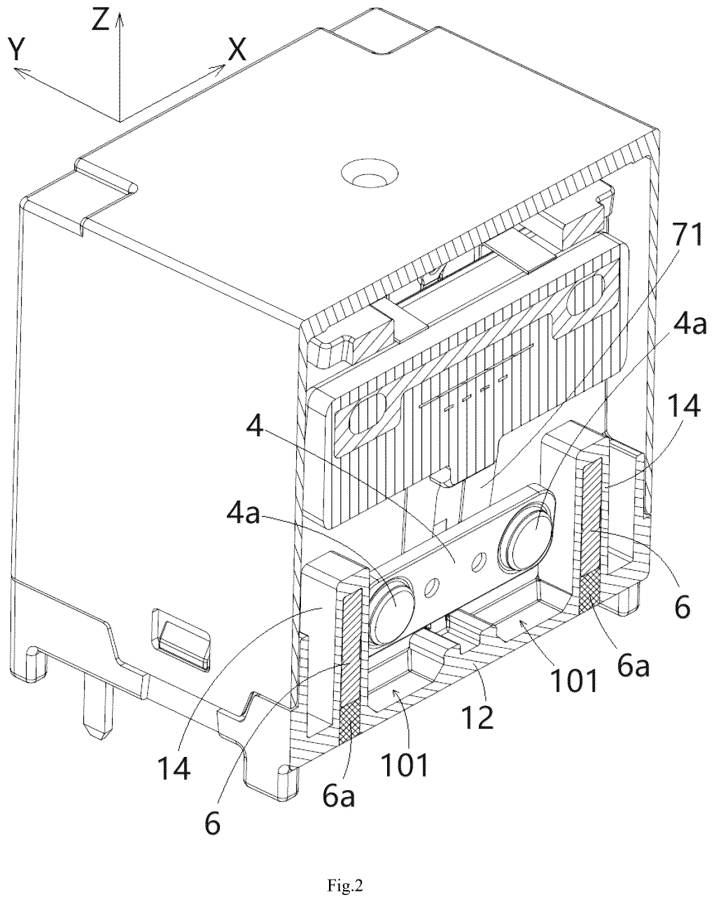

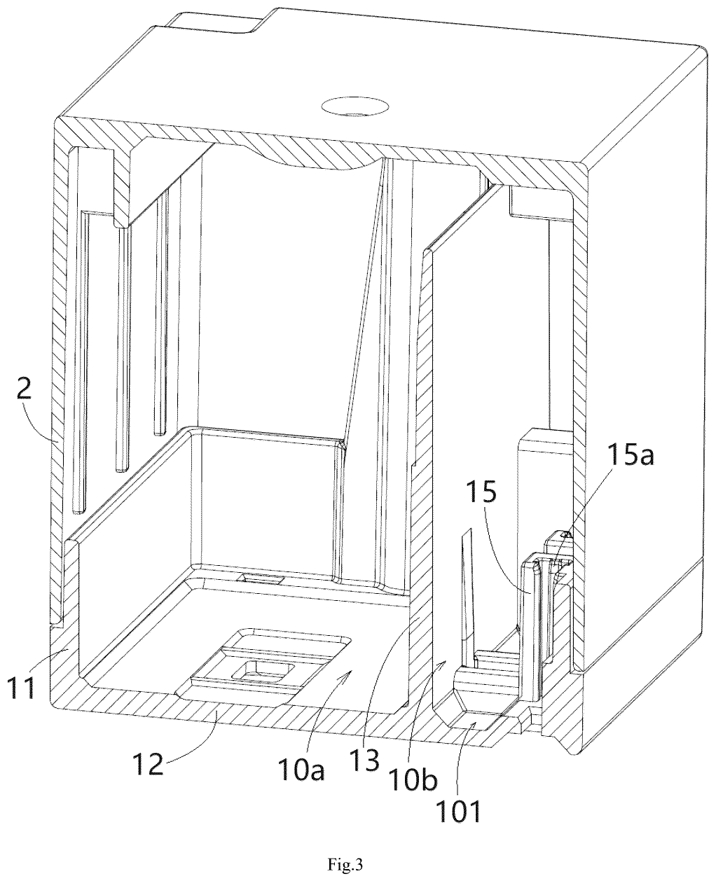

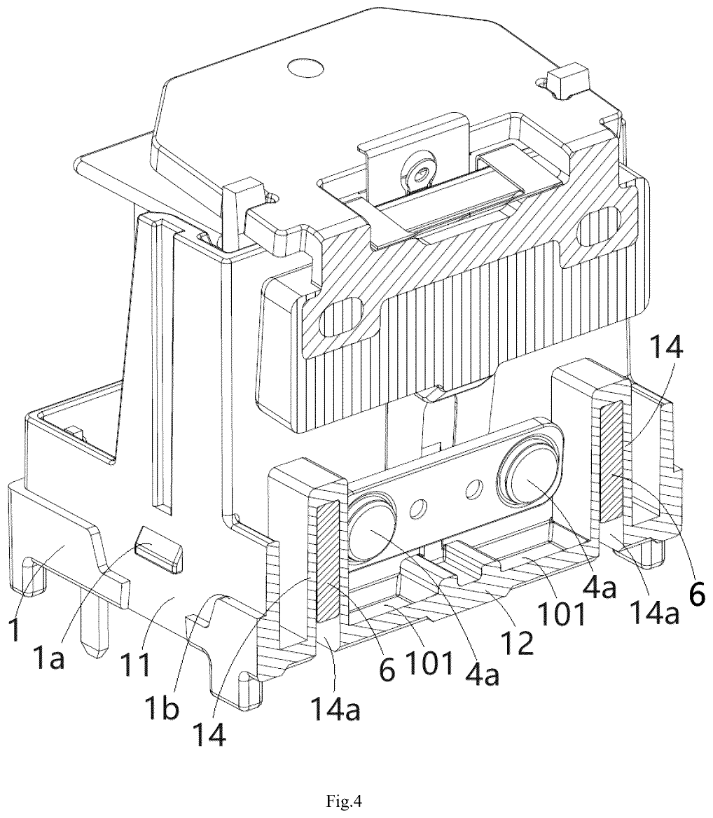

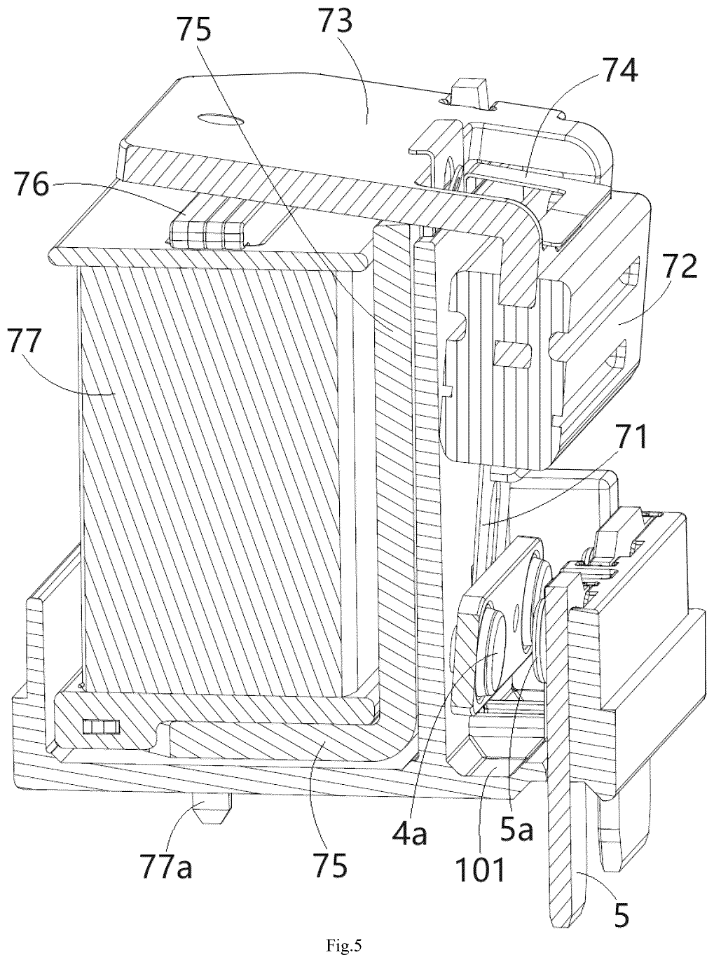

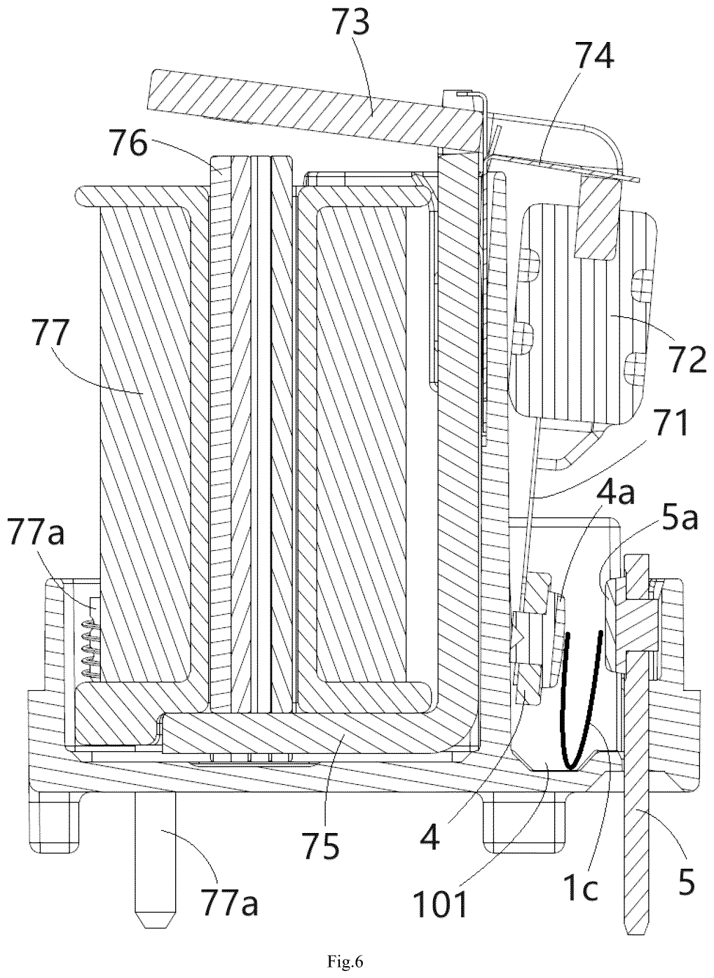

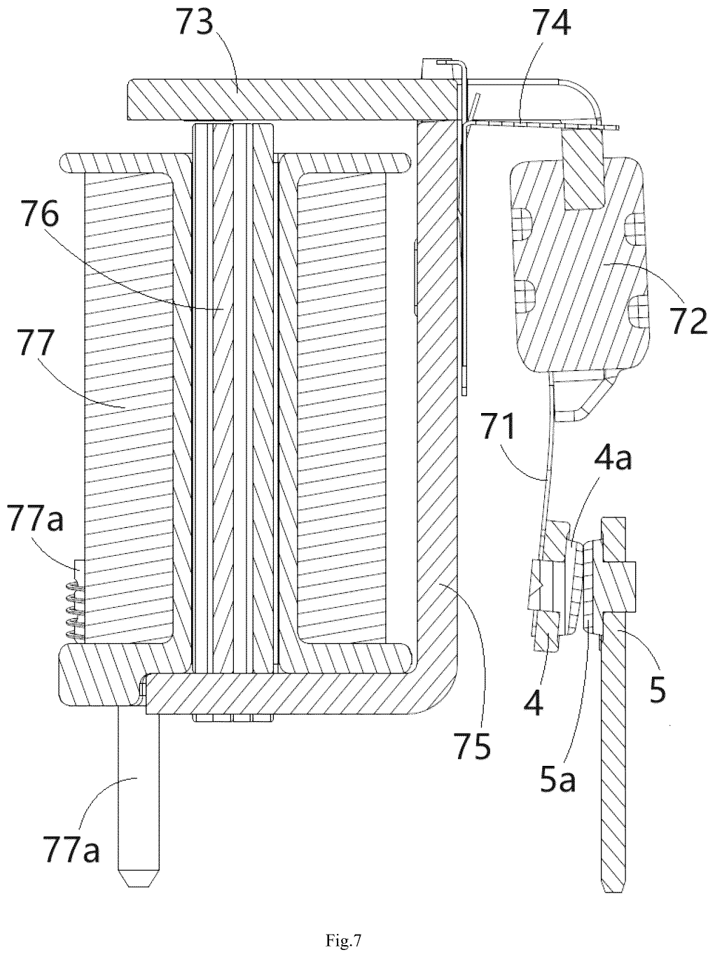

FIG. 1 shows an illustrative perspective view of a relay according to an exemplary embodiment of the present invention; FIG. 2 shows a transverse sectional view of a relay according to an exemplary embodiment of the present invention; FIG. 3 shows a longitudinal sectional view of a relay insulation base 1 and a housing 2 according to an exemplary embodiment of the present invention; FIG. 4 shows a transverse sectional view of a relay according to an exemplary embodiment of the present invention, where the housing 2 is not shown; FIG. 5 shows a longitudinal sectional view of a relay according to an exemplary embodiment of the present invention, wherein the housing 2 is not shown; FIG. 6 shows a plan sectional view of a relay according to an exemplary embodiment of the present invention, in which the movable contact 4a and the static contact 5a are in an electrically separated open position; FIG. 7 shows a plan sectional view of a relay according to an exemplary embodiment of the present invention, where the movable contact 4a and the static contact 5a are in the closed position of electrical contact.

As shown in FIGS. 1-7, in an exemplary embodiment of the present invention, an insulation base 1 is disclosed. The insulation base 1 is used for installation into a bottom opening of a housing 2 of a relay. The insulation base 1 includes a peripheral wall 11, a bottom wall 12, and a partition wall 13. The bottom wall 12 is connected to the bottom of the peripheral wall 11. The partition wall 13 is connected to the peripheral wall 11 and the bottom wall 12. The partition wall 13 is used to divide the internal space defined by the housing 2 and the insulation base 1 into a containment chamber 10a and an arc extinguishing chamber 10b. Two recesses 101 are formed on the inner side of the bottom wall 12 of the arc extinguishing chamber 10b, so that the electric arc 1c between one static contact 5a and one movable contact 4a of the relay can be pulled down into one recess 101 to increase the length of the electric arc 1c being pulled down.

In the illustrated embodiment, the electric arc 1c between one movable contact 4a and one static contact 5a of the relay can be pulled down into the recess 101 on the bottom wall 12 of the arc extinguishing chamber 10b by the magnetic field between the two arc extinguishing magnets 6. Therefore, the length of the electric arc 1c being pulled down can be increased, so that the electric arc 1c can be quickly extinguished, greatly improving the magnetic extinguishing effect of the relay. In addition, the electric arc between the other static contact 5a and the other movable contact 4a of the relay is stretched upwards by the magnetic field between the two arc extinguishing magnets 6. Due to the large space for upward stretching, the upward stretched arc can also be quickly extinguished.

The insulation base 1 has a transverse direction X, a longitudinal direction Y, and a height direction Z, the partition wall 13 extends along the transverse direction X and height direction Z, and two recesses 101 are arranged side by side in the transverse direction X.

The insulation base 1 further includes two magnet retaining portions 14. Two magnet retaining portions 14 are formed in the arc extinguishing chamber 10b for holding the two arc extinguishing magnets 6 of the relay. Two magnet retaining portions 14 are opposite in the transverse direction X, and two recesses 101 are located between the two magnet retaining portions 14.

The magnet retaining portion 14 is connected to the bottom wall 12 and the partition wall 13, and slots 14a for inserting arc extinguishing magnets 6 are formed in each of the two magnet retaining portions 14. The two arc extinguishing magnets 6 of the relay are adapted to be inserted into the slots 14a of the two magnet retaining portions 14, respectively. The slot 14a has an insertion port located on the outer side of the bottom wall 12 to allow the arc extinguishing magnet 6 to be inserted into the slot 14a of the magnet retaining portion 14 through the insertion port. The inner wall surface of the slot 14a is suitable for interference fit with the arc extinguishing magnet 6 to fix the arc extinguishing magnet 6 in the slot 14a.

As shown in FIGS. 1 to 7, in another exemplary embodiment of the present invention, there is a gap between the inner wall surface of the slot 14a and the arc extinguishing magnet 6, and a sealant 6a is injected into the insertion port of the slot 14a to seal the insertion port of the slot 14a and fix the arc extinguishing magnet 6 in the slot 14a.

The insulation base 1 also includes two terminal holding portions 15. Two terminal holding portions 15 are formed in the arc extinguishing chamber 10b for holding the two static terminals 5 of the relay. The two terminal holding portions 15 are arranged side by side in the transverse direction X and are spaced opposite to the partition wall 13. The terminal holding portion 15 is connected to the peripheral wall 11 and the bottom wall 12, and terminal slots 15a for inserting static terminals 55 are formed in each of the two terminal holding portions 15. The two static terminals 5 of the relay are suitable for being inserted into the terminal slots 15a of the two terminal holding portions 15, respectively. An opening is formed in the bottom wall 12 that communicates with the terminal slot 15a to allow a portion of the static terminal 55 to protrude from the insulation base 1 through the opening on the bottom wall 12.

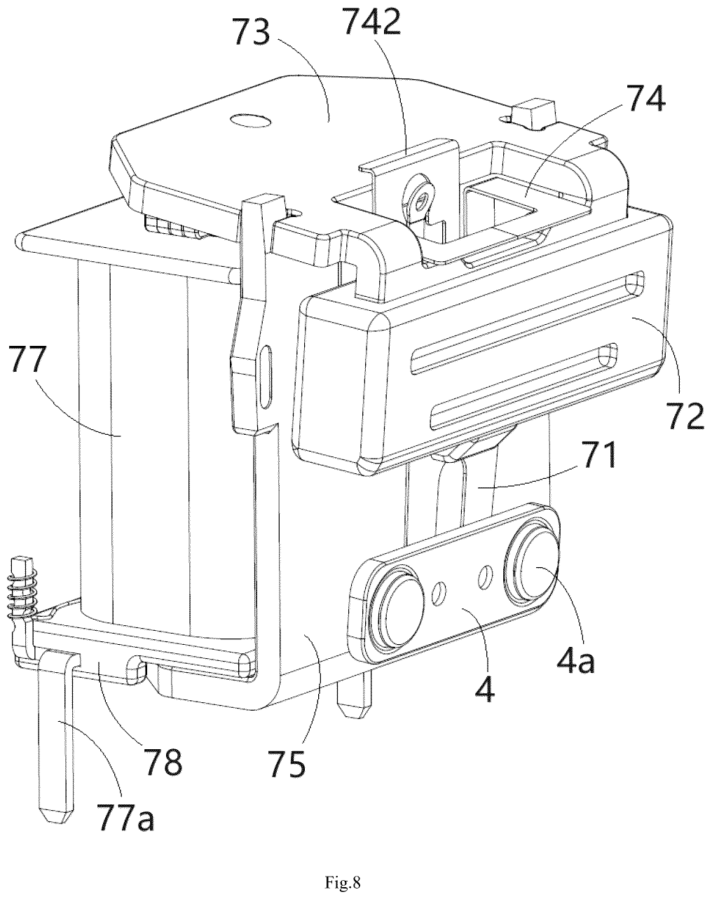

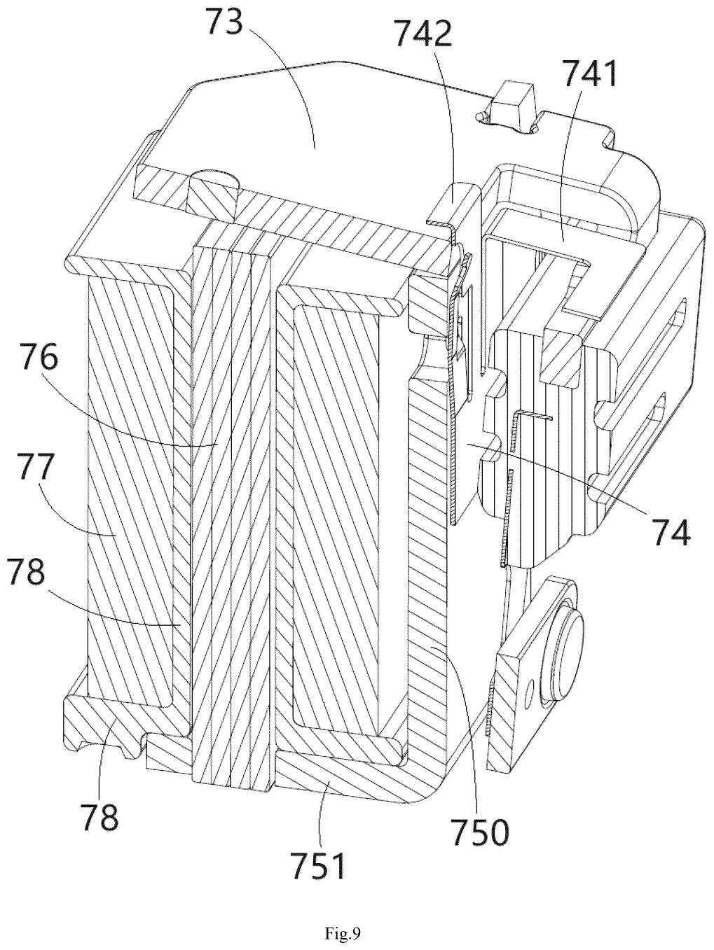

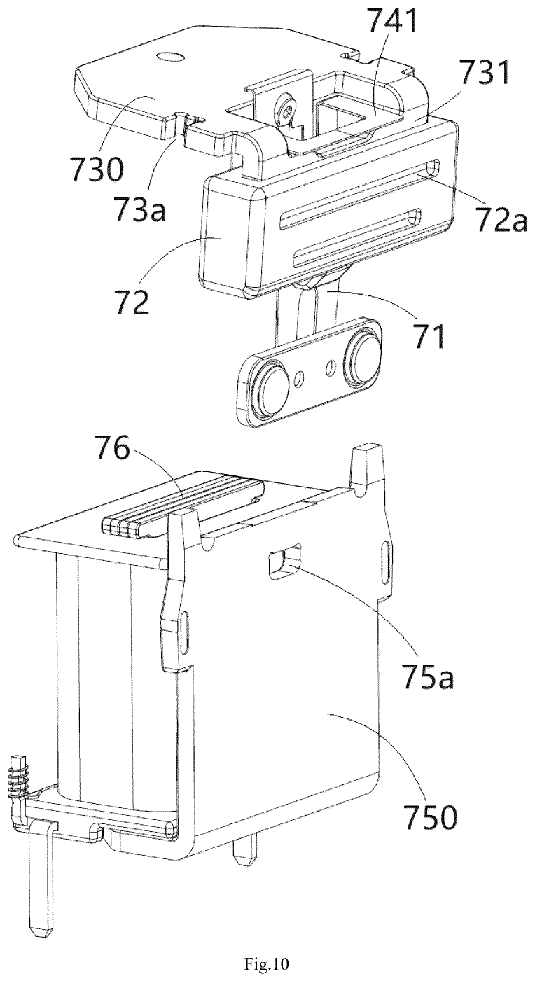

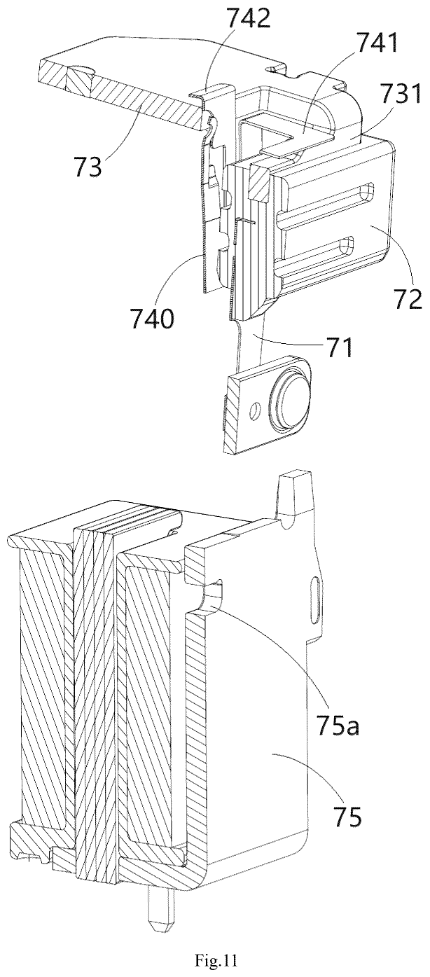

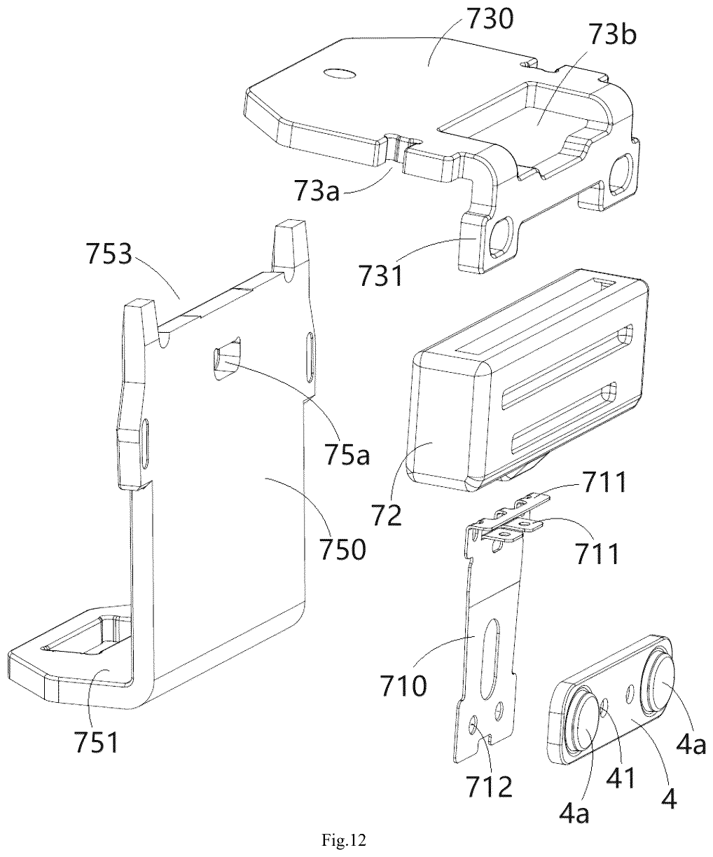

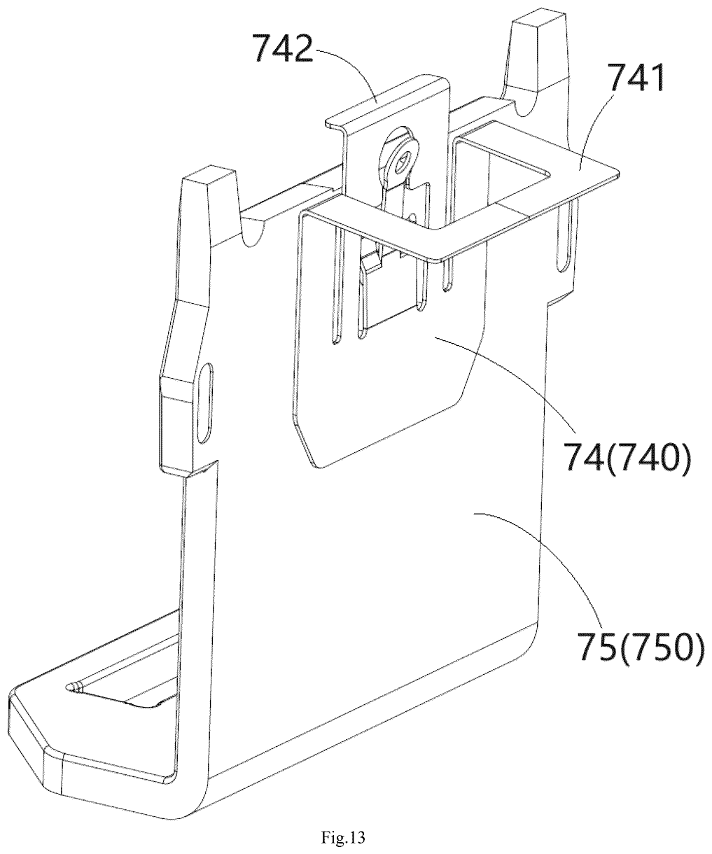

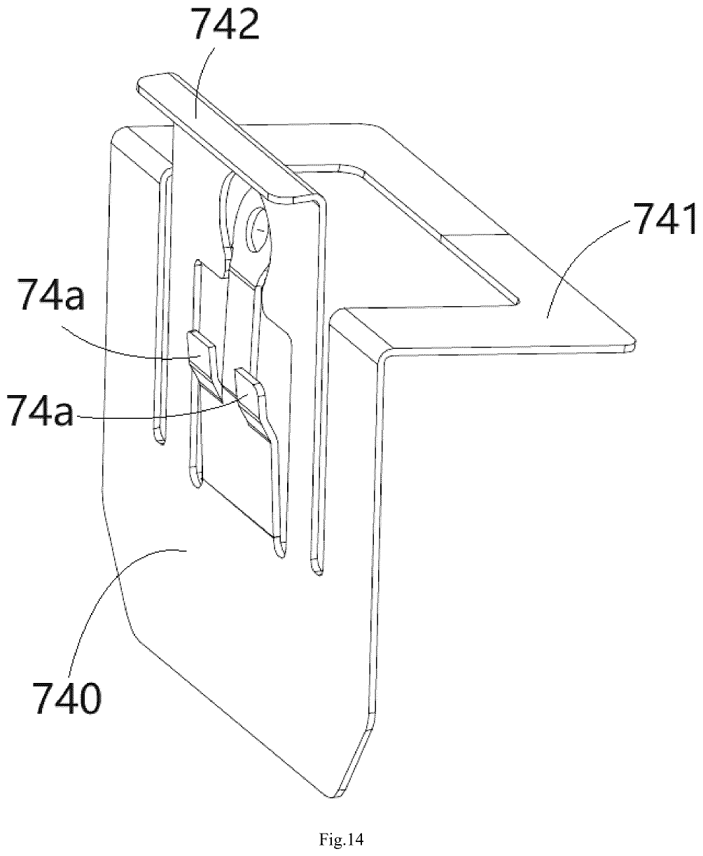

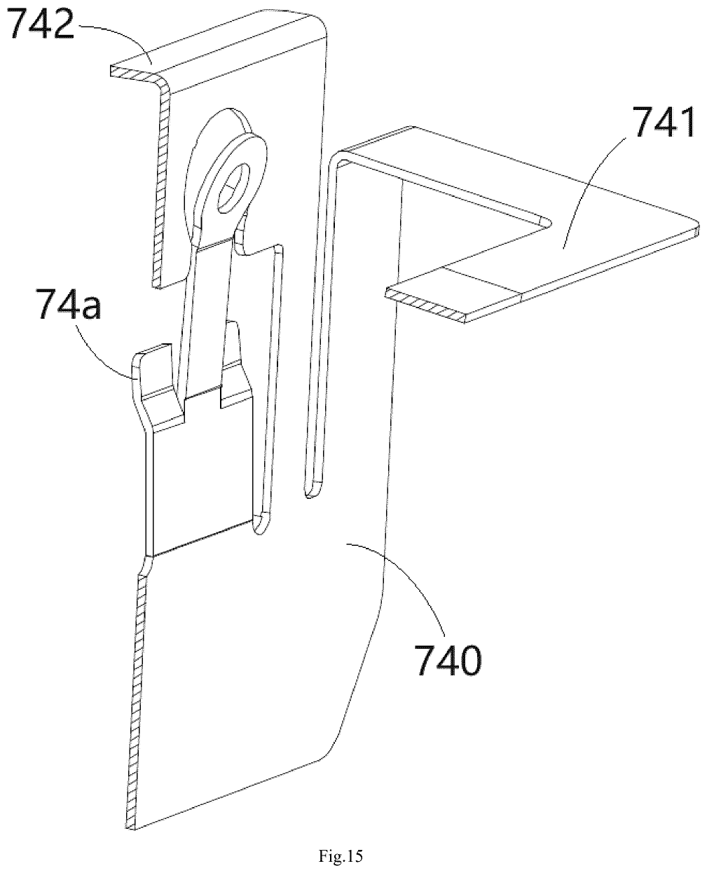

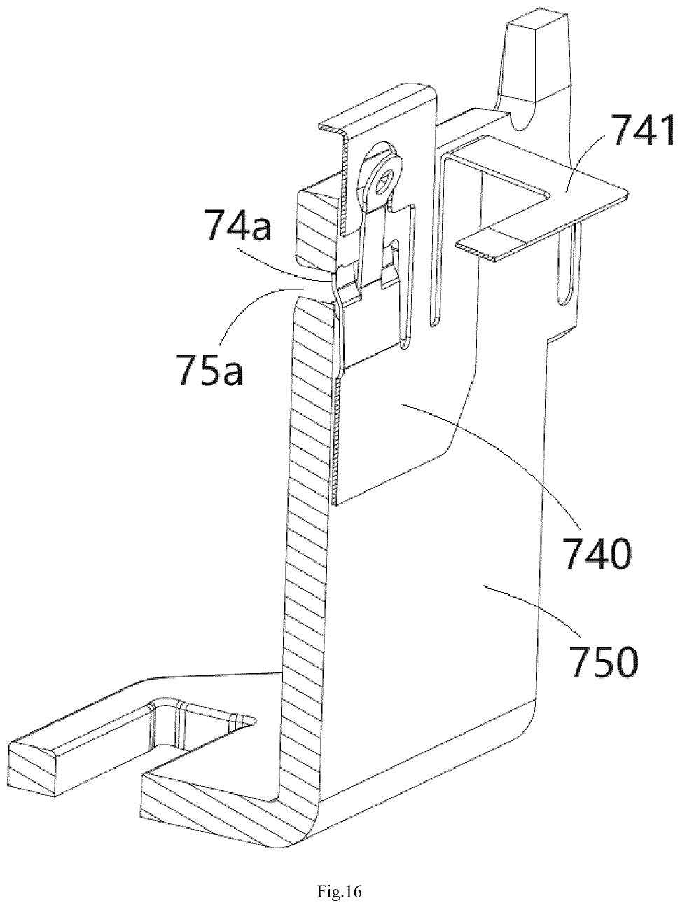

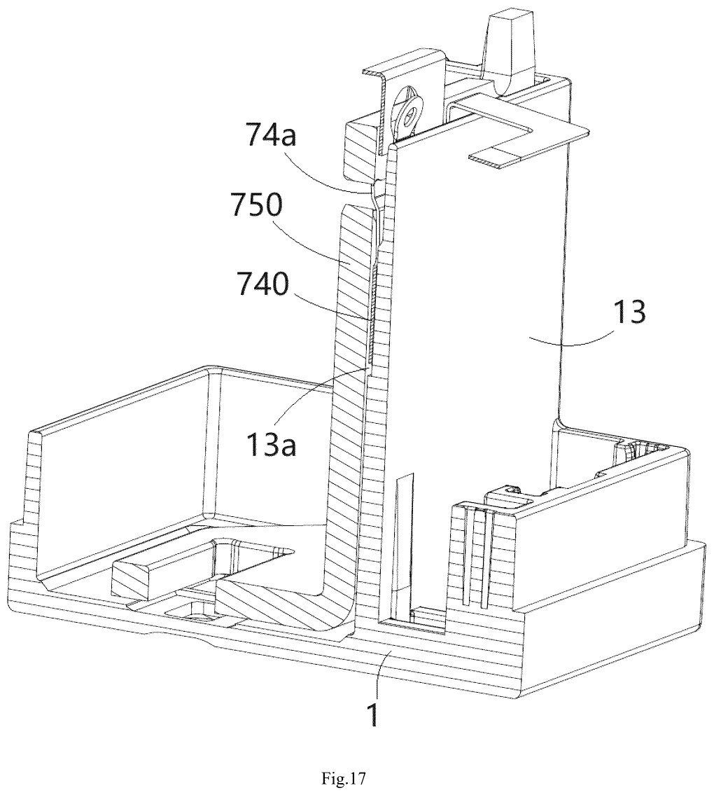

FIG. 8 shows an illustrative perspective view of a relay module according to an exemplary embodiment of the present invention; FIG. 9 shows a cross-sectional view of a relay module according to an exemplary embodiment of the present invention; FIG. 10 shows an illustrative exploded view of a relay module according to an exemplary embodiment of the present invention; FIG. 11 shows an exploded sectional view of a relay module according to an exemplary embodiment of the present invention; FIG. 12 shows an illustrative exploded view of a relay armature assembly according to an exemplary embodiment of the present invention; FIG. 13 shows an illustrative assembly view of the yoke 75 and reset leaf spring 74 of a relay according to an exemplary embodiment of the present invention; FIG. 14 shows an illustrative perspective view of the reset leaf spring 74 of a relay according to an exemplary embodiment of the present invention; FIG. 15 shows a cross-sectional view of the reset leaf spring 74 of a relay according to an exemplary embodiment of the present invention; FIG. 16 shows a cross-sectional view of the yoke 75 and reset leaf spring 75 of a relay according to an exemplary embodiment of the present invention; FIG. 17 shows a cross-sectional view of the yoke 75, reset leaf spring 74, and insulation base 1 of a relay according to an exemplary embodiment of the present invention.

As shown in FIGS. 1-17, in another exemplary embodiment of the present invention, a relay is also disclosed, which may be a DC electromagnetic relay. The relay includes: a housing 2, an insulation base 1, two static contacts 5a, two movable contacts 4a, and two arc extinguishing magnets 6. The housing 2 is formed with a bottom opening. The insulation base 1 is installed into the bottom opening of the housing 2. Two static contacts 5a are located in the arc extinguishing chamber 10b. Two movable contacts 4a are located in the arc extinguishing chamber 10b, for electrical contact with two static contacts 5a respectively. Two arc extinguishing magnets 6 are located in the arc extinguishing chamber 10b, used to extinguish the electric arc 1c between the static contact 5a and the movable contact 4a by magnetic blowing. The two recesses 101 on the bottom wall 12 of the arc extinguishing chamber 10b are located below the two movable contacts 4a and between the two arc extinguishing magnets 6, so that the electric arc 1c between one static contact 5a and one movable contact 4a of the relay can be pulled down into the recess 101 by the magnetic field between the two arc extinguishing magnets 6. Therefore, it is possible to increase the length of the electric arc 1c being pulled down, so that the electric arc 1c can be quickly extinguished, greatly improving the magnetic extinguishing effect of the relay. In addition, the electric arc between the other static contact 5a and the other movable contact 4a of the relay is stretched upwards by the magnetic field between the two arc extinguishing magnets 6. Due to the large space for upward stretching, the upward stretched electric arc can also be quickly extinguished.

In the illustrated embodiment, the arc extinguishing magnet 6 is inserted into the slot 14a of the magnet retaining portion 14 of the insulation base 1, and sealant 6a is poured into the insertion port of the slot 14a to seal the insertion port of the slot 14a and hold the arc extinguishing magnet 6 in the slot 14a.

The two arc extinguishing magnets 6 are rectangular in shape and face each other in the transverse direction X of the insulation base 1. The opposite sides of the two arc extinguishing magnets 6 have opposite polarities.

In the illustrated embodiment, the relay also includes two static terminals 5. Two static terminals 5 are respectively inserted into the terminal slots 15a of the two terminal holding portions 15 of the insulation base 1 and extend from the bottom wall 12 of the insulation base 1. Two static contacts 5a are respectively fixed to two static terminals 5 to be electrically connected to the two static terminals 5.

The relay also includes a movable terminal 4. The movable terminal 4 is located in the arc extinguishing chamber 10b. Two movable contacts 4a are respectively fixed to both ends of the movable terminal 4 to be electrically connected to the movable terminal 4. When the two movable contacts 4a are moved to the closed position where they are in electrical contact with the two static contacts 5a, the two static terminals 5 are electrically connected together via the movable terminal 4.

The relay further comprises a magnetic core 76, a yoke 75, and an armature assembly. The magnetic core 76 is set in the accommodating chamber 10a. The yoke 75 is set in the accommodating chamber 10a and fixed to the magnetic core 76. The armature assembly includes: an armature 73, a movable leaf spring 71, and an insulator 72. The armature 73 is installed on the yoke 75 in a movable manner, and can swing relative to the yoke 75 between an initial position and a suction position. The movable leaf spring 71 is suitable for being connected to the movable terminal 4, for applying elastic contact force to the movable contact 4a. The armature 73 and the movable leaf spring 71 are fixed to the insulator 72 and electrically isolated from each other by the insulator 72.

The insulator 72 is an injection molded part directly formed on the armature 73 and the movable leaf spring 71 through an embedded injection molding process, so that the armature 73, the movable leaf spring 71, and the insulator 72 are integrated into one piece. The armature 73 and the movable leaf spring 71 are respectively joined to the upper and lower sides of the insulator 72, and grooves 72a and/or ribs are formed on the front and rear sides of the insulator 72 to increase the creepage distance between the armature 73 and the movable leaf spring 71.

The movable leaf spring 71 includes a sheet-like body 710 and multiple bent wings 711. Multiple bent wings 711 are connected to one end of the sheet-like body 710 and bent vertically relative to the sheet-like body 710. One end of the sheet-like body 710 and multiple bent wings 711 are joined to the insulator 72 to increase the bonding force between the movable leaf spring 71 and the insulator 72.

The armature 73 includes a plate-shaped body 730 and a bent portion 731. The bent portion 731 is connected to one end of the plate-shaped body 730 and bent perpendicular to the plate-shaped body 730. The bent portion 731 is joined into the insulator 72, and the plate-shaped body 730 is adapted to be movably mounted on the yoke 75.

The relay further includes a reset leaf spring 74. The reset leaf spring 74 is fixed to the yoke 75 and pressed onto the armature 73, used to reset the armature 73 from the suction position to the initial position. The magnetic core 76 and the reset leaf spring 74 are respectively arranged on both sides of the yoke 75. The magnetic core 76 is used to apply electromagnetic attraction to the armature 73, and the reset leaf spring 74 is used to apply elastic reset force to the armature 73.

The yoke 75 includes a vertical plate 750 and a horizontal plate 751. A notch 753 is formed at the upper end of the vertical plate 750. The lower end of horizontal plate 751 is connected to the lower end of vertical plate 750. The lower end of the magnetic core 76 is fixed to the horizontal plate 751 of the yoke 75. On the plate-shaped body 730 of the armature 73, there is a neck 73a formed, which is movably engaged in the notch 753 of the yoke 75.

The yoke 75 is fixed in the slot of the insulation base 1 in the transverse direction X and longitudinal direction Y, and the yoke 75 is fixed to the bottom wall 12 of the insulation base 1 in the height direction Z by glue. The magnetic core 76 is riveted into the rivet hole of the horizontal plate 751 of the yoke 75.

The reset leaf spring 74 includes a vertical spring piece 740 and a pressing spring piece 741. The vertical spring piece 740 is fixed to the vertical plate 750 of the yoke 75. The upper end of the pressing spring piece 741 is connected to the vertical spring piece 740 and bent at a predetermined angle relative to the vertical spring piece 740. A mounting port 73b is formed in one end of the plate-shaped body 730 of the armature 73 to allow the vertical spring piece 740 to pass through. The pressing spring piece 741 is pressed against one side of the mounting port 73b of the armature 73 to apply elastic reset force to the armature 73.

A snap slot 75a is formed in the vertical plate 750 of the yoke 75, and an elastic buckle 74a is formed on the vertical spring piece 740 of the reset leaf spring 74. The elastic buckle 74a is engaged into the snap slot 75a to fix the reset leaf spring 74 to the yoke 75. A vertical slot 13a is formed in the side of the partition wall 13 of the insulation base 1 facing the vertical plate 750 of the yoke 75, and the vertical spring piece 740 of the reset leaf spring 74 is inserted into the vertical slot 13a of the partition wall 13.

The reset leaf spring 74 further includes a limit spring piece 742, which is connected to the upper end of the vertical spring piece 740 and located above the other side of the mounting port 73b of the armature 73. The limit spring piece 742 is used to constrain the neck 73a of the armature 73 in the notch 753 of the yoke 75, in order to prevent the armature 73 from detaching from the yoke 75.

The relay also includes a coil assembly. The coil assembly includes a coil skeleton 78, a coil 77, and two coil terminals 77a. The coil skeleton 78 has a central through-hole. The coil 77 is wound around the coil skeleton 78. Two coil terminals 77a are fixed to the coil skeleton 78 and connected to the two ends of the coil 77, respectively. The coil terminal 77a extends from the bottom wall 12 of the insulation base 1. The magnetic core 76 is installed in the central through-hole of the coil skeleton 78, and the upper end of the magnetic core 76 is exposed from the outside of the coil skeleton 78 for attracting the armature 73.

When the coil 77 is energized, the armature 73 is attracted to the suction position by the electromagnetic attraction of the magnetic core 76, and the two movable contacts 4a are moved to the closed position where they are in electrical contact with the two static contacts 5a, respectively. When the coil 77 are deenergized, the electromagnetic attraction force applied to the armature 73 disappears, and the armature 73 is reset to its initial position under the elastic reset force of the reset leaf spring 74, and the two movable contacts 4a are moved to the open position separated from the two static contacts 5a.

The peripheral wall 11 of the insulation base 1 is inserted into the housing 2 through the bottom opening of the housing 2. A protrusion 1a is formed on the outer side of the peripheral wall 11 of the insulation base 1, and a slot hole 2a is formed in the peripheral wall of the housing 2. The protrusion la is engaged into the slot hole 2a to fix the housing 2 to the insulation base 1.

A positioning step 1b is formed on the outer side of the peripheral wall 11 of the insulation base 1, and the positioning step 1b is pressed against the bottom surface 2b of the housing 2 to position the housing 2 in the height direction Z of the insulation base 1.

In another exemplary embodiment of the present invention, a relay armature assembly is also disclosed. The relay armature assembly includes: an armature 73, a movable leaf spring 71, and an insulator 72. The armature 73 is suitable for being movably installed on the yoke 75 of the relay, and can swing relative to the yoke 75 between an initial position and a suction position. The movable leaf spring 71 is suitable for being connected to a movable contact assembly of the relay, for applying elastic contact force to the movable contact assembly. The armature 73 and the movable leaf spring 71 are fixed to the insulator 72 and electrically isolated from each other by the insulator 72.

The insulator 72 is an injection molded part directly formed on the armature 73 and the movable leaf spring 71 through an embedded injection molding process, so that the armature 73, the movable leaf spring 71, and the insulator 72 are integrated into one piece.

The armature 73 and the movable leaf spring 71 are respectively joined to the upper and lower sides of the insulator 72, and grooves 72a and/or ribs are formed on the front and rear sides of the insulator 72 to increase the creepage distance between the armature 73 and the movable leaf spring 71.

The movable leaf spring 71 includes a sheet-like body 710 and multiple bent wings 711. Multiple bent wings 711 are connected to one end of the sheet-like body 710 and bent vertically relative to the sheet-like body 710. One end of the sheet-like body 710 and multiple bent wings 711 are joined to the insulator 72 to increase the bonding force between the movable leaf spring 71 and the insulator 72.

Through holes are formed in one end of the sheet-like body 710 and the bent wing 711, respectively, to engage with the insulator 72, in order to further increase the bonding force between the movable leaf spring 71 and the insulator 72.

A riveting hole 712 is formed in the other end of the sheet-like body 710 of the movable leaf spring 71, which is suitable for engaging with the riveting post 41 on the movable contact assembly, so that the movable contact assembly can be riveted to the other end of the sheet-like body 710 of the movable leaf spring 71.

The armature 73 includes a plate-shaped body 730 and a bent portion 731. The bent portion 731 is connected to one end of the plate-shaped body 730 and bent perpendicular to the plate-shaped body 730. The bent portion 731 is joined into the insulator 72, and the plate-shaped body 730 is adapted to be movably mounted on the yoke 75. A through-hole is formed in the bent portion 731 to engage with the insulator 72, in order to further increase the bonding force between the armature 73 and the insulator 72.

In another exemplary embodiment of the present invention, a relay module is also disclosed. The relay module includes a magnetic core 76, a yoke 75, a relay armature assembly, and a reset leaf spring 74. The yoke 75 is fixed to the insulation base 1. The lower end of magnetic core 76 is fixed to the yoke 75. The armature 73 of the relay armature assembly is movably mounted on the yoke 75, and can swing between the suction position in contact with the upper end of the magnetic core 76 and the initial position separated from the upper end of the magnetic core 76. The reset leaf spring 74 is fixed to the yoke 75 and pressed onto the armature 73, used to reset the armature 73 from the suction position to the initial position. The magnetic core 76 and the reset leaf spring 74 are respectively arranged on both sides of the yoke 75. The magnetic core 76 is used to apply electromagnetic attraction to the armature 73, and the reset leaf spring 74 is used to apply elastic reset force to the armature 73.

In the illustrated embodiment, the yoke 75 includes a vertical plate 750 and a horizontal plate 751. A notch 753 is formed at the upper end of the vertical plate 750. The lower end of horizontal plate 751 is connected to the lower end of vertical plate 750. The lower end of the magnetic core 76 is fixed to the horizontal plate 751 of the yoke 75. On the plate-shaped body 730 of the armature 73, there is a neck 73a formed, which is movably engaged in the notch 753 of the yoke 75.

The yoke 75 is fixed in the slot of the insulation base 1 in the transverse direction X and longitudinal direction Y, and the yoke 75 is fixed to the bottom wall 12 of the insulation base 1 in the height direction Z by glue. The magnetic core 76 is riveted into the rivet hole of the horizontal plate 751 of the yoke 75.

The reset leaf spring 74 includes a vertical spring piece 740 and a pressing spring piece 741. The vertical spring piece 740 is fixed to the vertical plate 750 of the yoke 75. The upper end of the pressing spring piece 741 is connected to the vertical spring piece 740 and bent at a predetermined angle relative to the vertical spring piece 740. A mounting port 73b is formed in one end of the plate-shaped body 730 of the armature 73 to allow the vertical spring piece 740 to pass through. The pressing spring piece 741 is pressed against one side of the mounting port 73b of the armature 73 to apply elastic reset force to the armature 73.

A snap slot 75a is formed in the vertical plate 750 of the yoke 75, and an elastic buckle 74a is formed on the vertical spring piece 740 of the reset leaf spring 74. The elastic buckle 74a is engaged in the snap slot 75a to fix the reset leaf spring 74 to the yoke 75.

The reset leaf spring 74 further includes a limit spring piece 742, which is connected to the upper end of the vertical spring piece 740 and located above the other side of the mounting port 73b of the armature 73. The limit spring piece 742 is used to constrain the neck 73a of the armature 73 in the notch 753 of the yoke 75, in order to prevent the armature 73 from detaching from the yoke 75.

The relay module also includes a coil assembly. The coil assembly includes a coil skeleton 78, a coil 77, and two coil terminals 77a. The coil skeleton 78 has a central through-hole. The coil 77 is wound around the coil skeleton 78. Two coil terminals 77a are fixed to the coil skeleton 78 and connected to the two ends of the coil 77, respectively. The magnetic core 76 is installed in the central through-hole of the coil skeleton 78, and the upper end of the magnetic core 76 is exposed from the outside of the coil skeleton 78 for attracting the armature 73.

In another exemplary embodiment of the present invention, a relay is also disclosed. The relay includes: a housing 2, a relay module, an insulation base 1, and two static contact assemblies. The housing 2 has a bottom opening. The relay module is located in the housing 2. The insulation base 1 is installed into the bottom opening of the housing 2. Two static contact assemblies are fixed to the insulation base 1 for electrical contact with the movable contact assembly.

The movable contact assembly includes a movable terminal 4 and two movable contacts 4a. The movable terminal 4 is fixed to the movable leaf spring 71. Two movable contacts 4a are respectively fixed to both ends of the movable terminal 4. The static contact assembly includes: a static terminal 5 and a static contact 5a. The static terminal 5 is fixed to the insulation base 1. The static contact 5a is fixed to the static terminal 5. Two movable contacts 4a are used to make electrical contact with the static contacts 5a of two static contact assemblies, respectively, to electrically connect the static terminals 5 of the two static contact assemblies.

When the armature 73 is attracted to the suction position, the two movable contacts 4a are moved to the closed position in electrical contact with the two static contacts 5a, respectively. When the armature 73 is reset to its initial position, the two movable contacts 4a are moved to the open position separated from the two static contacts 5a.

The insulation base 1 includes a peripheral wall 11, a bottom wall 12, and a partition wall 13. The bottom wall 12 is connected to the bottom of the peripheral wall 11. The partition wall 13 is connected to the peripheral wall 11 and the bottom wall 12. The partition wall 13 divides the internal space defined by the housing 2 and the insulation base 1 into a containment chamber 10a and an arc extinguishing chamber 10b. The coil assembly and the yoke 75 are arranged in the accommodating chamber 10a, and the movable contact assembly and the static contact assembly are arranged in the arc extinguishing chamber 10b.

The relay further comprises two arc extinguishing magnets 6, which are arranged in the arc extinguishing chamber 10b. There are two recesses 101 formed on the inner side of the bottom wall 12 of the arc extinguishing chamber 10b, which are located below the two movable contacts 4a and between the two arc extinguishing magnets 6. This allows the electric arc 1c between one static contact 5a and one movable contact 4a of the relay to be pulled down into the recess 101 by the magnetic field between the two arc extinguishing magnets 6, thereby increasing the length of the electric arc 1c being pulled down.

The insulation base 1 further includes two magnet retaining portions 14, which are formed in the arc extinguishing chamber 10b. A slot 14a is formed in the magnet retaining portion 14, and two arc extinguishing magnets 6 are respectively inserted into the slots 14a of the two magnet retaining portions 14.

The slot 14a has an insertion port located on the outer side of the bottom wall 12, and the arc extinguishing magnet 6 is inserted into the slot 14a of the magnet retaining portion 14 through the insertion port.

The insulation base 1 further includes two terminal holding portions 15, which are formed in the arc extinguishing chamber 10b. A terminal slot 15a is formed in the terminal holding portion 15, and two static terminals 5 are respectively inserted into the terminal slots 15a of the two terminal holding portions 15.

The peripheral wall 11 of the insulation base 1 is inserted into the housing 2 through the bottom opening of the housing 2. A protrusion la is formed on the outer side of the peripheral wall 11 of the insulation base 1, and a slot hole 2a is formed in the peripheral wall of the housing 2. The protrusion la is engaged with the slot hole 2a to fix the housing 2 to the relay insulation base 1.

A vertical slot 13a is formed in the side of the partition wall 13 of the insulation base 1 facing the vertical plate 750 of the yoke 75, and the vertical spring piece 740 of the reset leaf spring 74 is inserted into the vertical slot 13a of the partition wall 13.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. An insulation base for installation into a bottom opening of a housing of a relay, the insulation base comprising:
a peripheral wall;
a bottom wall connected to a bottom of the peripheral wall; and
a partition wall connected to the peripheral wall and the bottom wall, the partition wall divides an internal space defined by the housing and the insulation base into a containment chamber and an arc extinguishing chamber, two recesses are formed on an inner side of the bottom wall of the arc extinguishing chamber, so that an electric arc between a static contact and a movable contact of the relay can be pulled down into the recess to increase a length of the electric.

2. The insulation base according to claim 1, wherein the insulation base has a transverse direction, a longitudinal direction, and a height direction, and the partition wall extends along the transverse direction and the height direction, with the two recesses are arranged side by side in the transverse direction.

3. The insulation base according to claim 2, further comprising two magnet retaining portions formed in the arc extinguishing chamber and adapted to hold two arc extinguishing magnets of the relay, the two magnet retaining portions being opposite in the transverse direction, and the two recesses located between the two magnet retaining portions.

4. The insulation base according to claim 3, wherein the magnet retaining portion is connected to the bottom wall and the partition wall, and a slot for inserting the arc extinguishing magnet is formed in each of the two magnet retaining portions, the two arc extinguishing magnets of the relay are adapted to be inserted into the slots of the two magnet retaining portions, respectively.

5. The insulation base according to claim 4, wherein the slot has an insertion port on an outer side of the bottom wall to allow the arc extinguishing magnet to be inserted into the slot of the magnet retaining portion through the insertion port.

6. The insulation base according to claim 5, wherein a gap is defined between an inner wall surface of the slot and the arc extinguishing magnet, and sealant is poured into the insertion port of the slot to seal the insertion port of the slot and fix the arc extinguishing magnet within the slot.

7. The insulation base according to claim 2, further comprising two terminal holding portions formed in the arc extinguishing chamber for holding two static terminals of the relay, wherein:
the two terminal holding portions are arranged side by side in the transverse direction and are spaced opposite to the partition wall;
the terminal holding portion is connected to the peripheral wall and the bottom wall, and a terminal slot for inserting the static terminal is formed in each of the two terminal holding portions, the two static terminals of the relay are adapted to be respectively inserted into the terminal slots of the two terminal holding portions; and
an opening is formed on the bottom wall that communicates with the terminal slot to allow a portion of the static terminal to protrude from the insulation base through the opening on the bottom wall.

8. A relay, comprising:
a housing formed with a bottom opening;
the insulation base of claim 1, installed into the bottom opening of the housing;
two static contacts located in the arc extinguishing chamber;
two movable contacts located in the arc extinguishing chamber for electrical contact with the two static contacts respectively; and
two arc extinguishing magnets located in the arc extinguishing chamber for extinguishing an electric arc between the static contact and the movable contact by magnetic blowing, wherein the two recesses on the bottom wall of the arc extinguishing chamber are respectively located below the two movable contacts and between the two arc extinguishing magnets, so that the electric arc between the static contact and the movable contact can be pulled down into the recess by a magnetic field between the two arc extinguishing magnets.

9. The relay according to claim 8, wherein the arc extinguishing magnet is inserted into the slot of the magnet retaining portion of the insulation base, and sealant is poured into the insertion port of the slot to seal the insertion port of the slot and hold the arc extinguishing magnet in the slot.

10. The relay according to claim 8, wherein the two arc extinguishing magnets are rectangular in shape and face each other in the transverse direction of the insulation base, and the opposite sides of two arc extinguishing magnets have opposite polarities.

11. The relay according to claim 8, further comprising two static terminals respectively inserted into the terminal slots of the two terminal holding portions of the insulation base and extend from the bottom wall of the insulation base, wherein the two static contacts are respectively fixed to the two static terminals to be electrically connected to the two static terminals.

12. The relay according to claim 8, further comprising a movable terminal which is located in the arc extinguishing chamber, wherein the two movable contacts are respectively fixed to both ends of the movable terminal to be electrically connected to the movable terminal, when the two movable contacts are moved to the closed position in electrical contact with the two static contacts, the two static terminals are electrically connected together via the movable terminal.

13. The relay according to claim 12, further comprising:
a yoke which arranged in the accommodating chamber and fixed to the insulation base;
a magnetic core installed in the accommodating chamber and its lower end is fixed to the yoke; and
an armature assembly, including:
an armature movably installed on the yoke and can be swinged relative to the yoke between an initial position and a suction position;
a movable leaf spring adapted to be connected to the movable terminal for applying elastic contact force to the movable contact; and
an insulator, wherein the armature and the movable leaf spring are fixed to the insulator and are electrically isolated from each other by the insulator.

14. The relay according to claim 13, wherein the insulator is an injection molded part directly formed on the armature and the movable leaf spring through an embedded injection molding process, so that the armature, the movable leaf spring, and the insulator are integrated into one piece.

15. The relay according to claim 13, wherein the armature and the movable leaf spring are respectively joined to the upper and lower sides of the insulator, and grooves and/or ribs are respectively formed on the front and rear sides of the insulator to increase the creepage distance between the armature and the movable leaf spring.

16. The relay according to claim 13, wherein the movable leaf spring comprises:
a sheet-like body; and
multiple bent wings connected to one end of the sheet-like body and bent vertically relative to the sheet-like body, wherein one end of the sheet-like body and the multiple bent wings are joined into the insulator to increase the bonding force between the movable leaf spring and the insulator.

17. The relay according to claim 13, wherein the armature comprises:
a plate-shaped body; and
a bent portion connected to one end of the plate-shaped body and bent perpendicular to the plate-shaped body, wherein the bent portion is joined into the insulator, and the plate-shaped body is adapted to be movably mounted on the yoke.

18. The relay according to claim 17, further comprising a reset leaf spring fixed to the yoke and pressed onto the armature, and adapted to reset the armature from the suction position to the initial position, wherein the magnetic core and the reset leaf spring are respectively arranged on both sides of the yoke, the magnetic core is used to apply electromagnetic attraction to the armature, and the reset leaf spring is used to apply elastic reset force to the armature.

19. The relay according to claim 18, wherein:
the yoke comprises:
a vertical plate with a notch formed at the upper end of the vertical plate; and
a horizontal plate connected to the lower end of the vertical plate, wherein a neck is formed on the plate-shaped body of the armature, the neck is movably engaged in the notch of the yoke; and
the reset leaf spring comprises:
a vertical spring piece fixed to the vertical plate of the yoke; and
a pressing spring piece connected to the upper end of the vertical spring piece and bent at a predetermined angle relative to the vertical spring piece, wherein a mounting port is formed in one end of the plate-shaped body of the armature to allow the vertical spring piece to pass through, and the pressing spring piece is pressed on one side of the mounting port of the armature to apply elastic reset force to the armature.

20. The relay according to claim 19, wherein:
a snap slot is formed on the vertical plate of the yoke, and an elastic buckle is formed on the vertical spring piece of the reset leaf spring, the elastic buckle is engaged into the snap slot to fix the reset leaf spring to the yoke; and
a vertical slot is formed in one side of the partition wall of the insulation base facing the vertical plate of the yoke, and the vertical spring piece of the reset leaf spring is inserted into the vertical slot of the partition wall.

21. The relay according to claim 19, wherein the reset leaf spring further comprises a limit spring piece connected to the upper end of the vertical spring piece and located above the other side of the mounting port of the armature, wherein the limit spring piece is adapted to constrain the neck of the armature in the notch of the yoke to prevent the armature from detaching from the yoke.

22. The relay according to claim 18, further comprising a coil assembly, including:
a coil skeleton with a central through-hole;
a coil wound around the coil skeleton; and
two coil terminals fixed to the coil skeleton and connected to both ends of the coil, respectively, wherein the magnetic core is installed in the central through-hole of the coil skeleton, and the upper end of the magnetic core is exposed from the outside of the coil skeleton for adsorbing the armature.

23. The relay according to claim 22, wherein:
when the coil is energized, the armature is attracted to the suction position by the electromagnetic attraction of the magnetic core, and the two movable contacts are moved to the closed position in electrical contact with the two static contacts respectively; and
when the coil is deenergized, the electromagnetic suction force applied to the armature disappears, and the armature is reset to the initial position under the elastic reset force of the reset leaf spring, and the two movable contacts are moved to the open position separated from the two static contacts.

24. The relay according to claim 8, wherein:
the peripheral wall of the insulation base is inserted into the housing through the bottom opening of the housing, and a protrusion is formed on the outer side of the peripheral wall of the insulation base, a slot hole is formed in the peripheral wall of the housing, and the protrusion is engaged into the slot hole to fix the housing to the insulation base; and
a positioning step is formed on the outer side of the peripheral wall of the insulation base, and the positioning step is pressed against the bottom surface of the housing to position the housing in the height direction of the insulation base.
